(19) United States
(12) Patent Application Publication
(10) Pub. No.: US 2025/0297736 A1
(43) Pub. Date: Sep. 25, 2025

(54) TUBULAR SUPPLY DEVICE, A HEAT GENERATING PLANT AND A METHOD

(71) Applicant: ECOMB AB, Södertälje (SE)

(72) Inventor: Ulf Hagström, Nyköping (SE)

(73) Assignee: ECOMB AB, Södertälje (SE)

(21) Appl. No.: 18/868,840

(22) PCT Filed: May 24, 2023
(86) PCT No.: PCT/SE2023/050508

§ 371 Date: Nov. 25, 2024

(30) Foreign Application Priority Data
May 27, 2022 (SE) 2250636-4

(51) Int. Cl. F23L 7/00; F23L 9/02

(52) U.S. Cl. CPC F23L 7/007; F23L 9/02; F23L 2900/07005

(57) ABSTRACT

Provided is a tubular supply device for supplying gases to a combustion chamber in a heat-generating plant. The supply device includes a tube in the form of a straight lance and having an outer lateral wall for extending into the combustion chamber from a side wall. The supply device also includes a number of nozzle arrangements for expelling the gases into the combustion chamber. Each nozzle arrangement has an inner nozzle connectable to an oxygen source and arranged for supplying pure oxygen from said oxygen source into the combustion chamber. Each nozzle arrangement also has an outer nozzle connectable in a flue gas recirculation loop of the plant and arranged for supplying flue gas flowing in said flue gas recirculation loop into the combustion chamber.

### TECHNICAL FIELD

The present disclosure relates to a tubular supply device for supplying gases to a combustion chamber in a heat-generating plant.

### BACKGROUND

Generally, heat generating plants, such as power plants or combined heat and power plant (CHP plant), e.g. comprising boilers, incinerator furnaces and technically corresponding apparatuses are designed to combust or burn different kinds of fuels using air for providing the oxygen. Air contains nitrogen as its major component. Since nitrogen is generally inert and thus not consumed during the combustion, it exits the combustion chamber as part of the flue gas there from. Traditionally, the flue gas, comprising the nitrogen and the carbon dioxide formed by the combustion, is released into the environment e.g. via a chimney of the plant. However, in view of global warming concerns, there is now a move towards preventing the carbon dioxide from being released into the environment using so called Carbon Capture and Storage (CCS) techniques. Then, the carbon dioxide first needs to be isolated from the rest of the flue gas, mainly nitrogen, in a rather costly process. It would thus be advantageous to operate the plant such that the flue gas contains a higher concentration of carbon dioxide and a lower concentration of other compounds, mainly nitrogen.

Instead of burning the fuel in air, pure oxygen may be added to the combustion chamber, to increase the carbon dioxide concentration in the flue gas. However, legacy plants are typically designed for using air and may not easily be redesigned for using oxygen. Volume and heat flows are very different when using pure oxygen instead of air.

Supply devices for supplying fluid to an internal combustion chamber of a heat generating plant, such as a boiler, an incinerator furnace and technically corresponding apparatus are known from SE 9201747-4 publication number 502 188and SE 9304038-4 publication number 502 283 both in the same name of ECOMB and their foreign counterparts.

These known fluid supply devices provide comparatively low emission levels and great flexibility and enable adjustments to desired emission levels to be achieved quickly and reliably. This is attained by arranging a supply device comprising at least one tube to be inserted horizontally into the combustion chamber.

Said devices also simplify de-sooting and cleaning of the tubes included in the device, a feature which also enhances the yield of the combustion and vaporisation process respectively.

The devices also enable different fluids or solids to be supplied at different points of time, through one or more of said tubes, so that a new optimal operating point can be set in relation to the prevailing operating state of the combustion chamber. A particular advantage afforded by the known supply devices is that one or more tubes can be withdrawn while still enabling the combustion or gasification process to continue with the use of the remaining tubes.

Other types of supply devices are described in DE 306 765 (Bauer) and U.S. Pat. No. 5,112,216 (Tenn) for example.

A supply device should be able to operate reliably over a long period of time in a demanding environment. The tube that is inserted into the combustion chamber, according to prior art, is subjected to high stresses as a result of the high temperature and the corrosive environment that prevail.

In view of changing conditions within a combustion chamber, the optimal place for injecting fluid or solid particles into the combustion gases of the chamber by means of a supply device may vary over time. This has been solved by using a plurality of tubes and/or a plurality of injection holes in each tube.

### SUMMARY

It is an objective of the present invention to provide improved combustion and flue gas handling in a heat-generating plant, e.g. a power plant or combined heat and power plant (CHP plant), in which a fuel is burnt in the presence of oxygen in a combustion chamber of the plant.

According to an aspect of the present invention, there is provided a tubular supply device for supplying gases to a combustion chamber in a heat-generating plant. The supply device comprises a tube in the form of a straight lance and having an outer lateral wall, configured for extending, preferably horizontally, into the combustion chamber from a side wall of said combustion chamber. The supply device comprises a plurality of nozzle arrangements arranged through the outer lateral wall for expelling the gases into the combustion chamber from within the tube in a direction which is perpendicular to the lateral wall. Each nozzle arrangement comprises an inner nozzle connectable to an oxygen source via inner piping in the supply device. The inner nozzle is arranged for supplying pure oxygen from said oxygen source into the combustion chamber via said inner piping and the inner nozzle. Each nozzle arrangement also comprises an outer nozzle, surrounding the inner nozzle, preferably concentrically. The outer nozzle is connectable in a flue gas recirculation loop of the plant via outer piping in the supply device. The outer nozzle is arranged for supplying flue gas flowing in said flue gas recirculation loop into the combustion chamber via said outer piping and the outer nozzle. The outer piping encloses the inner piping at the nozzle arrangement within the tube.

According to another aspect of the present invention, there is provided a heat-generating plant comprising a combustion chamber, an oxygen source, a flue gas recirculation loop, and at least one tubular supply device in accordance with the present disclosure extending into the combustion chamber from the side wall. For each of the at least one tubular supply device the inner nozzle is connected to the oxygen source via the inner piping, and the outer nozzle is connected in the flue gas recirculation loop via the outer piping.

According to another aspect of the present invention, there is provided a method for supplying gases to a combustion chamber in an embodiment of the heat-generating plant of the present disclosure. The method comprises, from the oxygen source, supplying gaseous pure oxygen into the combustion chamber via the inner nozzle of each of the nozzle arrangements. The method also comprises supplying gaseous carbon dioxide into the combustion chamber via the outer nozzle of each of the nozzle arrangements.

By supplying pure oxygen rather than air to the combustion chamber for burning the fuel therein, substantially pure carbon dioxide can be obtained as the flue gas, typically after removing water vapour by condensation, facilitating collecting and storing the carbon dioxide instead of releasing it to the environment. However, conventional plants are configured for using air, not pure oxygen, and it would be very costly, if at all possible, to convert them for use of pure oxygen. In accordance with the present invention, this problem is solved by mixing the oxygen with recirculated flue gas, essentially carbon dioxide, the carbon dioxide then replacing the nitrogen in the regularly used air. The oxygen is mixed with the flue gas by supplying the oxygen via an inner nozzle which is surrounded by an outer nozzle via which the flue gas is supplied. Thus, by recirculation of flue gas, and mixing of the flue gas with oxygen when supplying it into the combustion chamber, legacy plants configured for burning in air can be used also for pure oxygen. Since the part of the flue gas which is not recirculated is predominantly carbon dioxide, e.g. substantially pure carbon dioxide or at least with a much higher carbon dioxide content than flue gas from a plant using air, it can more easily be subjected to a Carbon Capture and Storage (CCS) process for preventing release of the carbon dioxide into the atmosphere. In the absence of nitrogen from air, there may be no need to release any part of the flue gas into the surroundings, possibly obviating the need for a chimney.

It is to be noted that any feature of any of the aspects may be applied to any other aspect, wherever appropriate. Likewise, any advantage of any of the aspects may apply to any of the other aspects. Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second” etc. for different features/components of the present disclosure are only intended to distinguish the features/components from other similar features/components and not to impart any order or hierarchy to the features/components.

### BRIEF DESCRIPTION OF THE DRAWINGS

Embodiments will be described, by way of example, with reference to the accompanying drawings, in which:

FIG. 1 is a schematic bottom view of a tubular supply device, in accordance with some embodiments of the present invention.

FIG. 2 is a schematic view in longitudinal section of a tubular supply device, in accordance with some embodiments of the present invention.

FIG. 3 is a schematic sectional side view of a heat-generating plant, in accordance with some embodiments of the present invention.

FIG. 4 is a flow chart of an embodiment of the method of the present invention.

### DETAILED DESCRIPTION

Embodiments will now be described more fully hereinafter with reference to the accompanying drawings, in which certain embodiments are shown. However, other embodiments in many different forms are possible within the scope of the present disclosure. Rather, the following embodiments are provided by way of example so that this disclosure will be thorough and complete, and will fully convey the scope of the disclosure to those skilled in the art. Like numbers refer to like elements throughout the description. When pure oxygen, or substantially pure oxygen or the like, is mentioned herein, gaseous oxygen of at least 99% purity, thus having at most 1% impurities, is intended. Similarly, when pure carbon dioxide, or substantially pure carbon dioxide or the like, is mentioned herein, gaseous carbon dioxide of at least 99% purity, thus having at most 1% impurities, is intended. Percentages given herein are by volume unless otherwise stated. Flue gas is regarded as dry if it contains less than 1% water vapour.

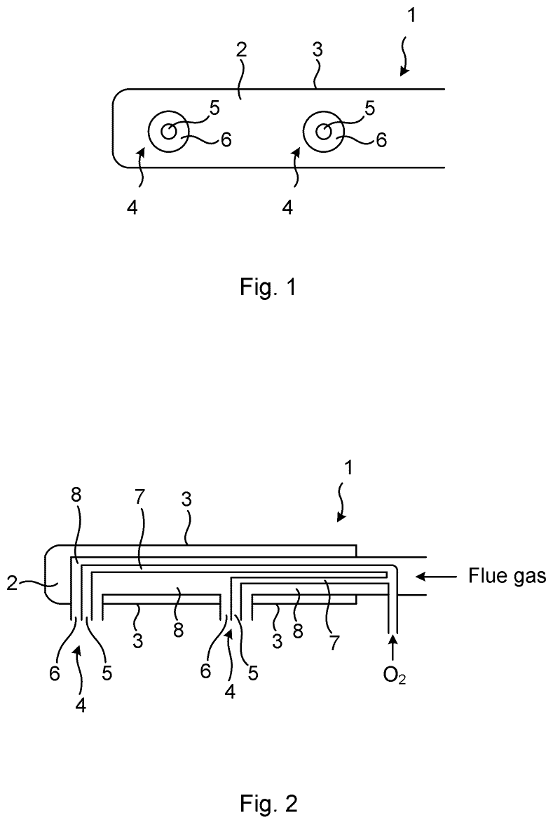

FIGS. 1 and 2 illustrate an example of a tubular supply device 1 for supplying gases into a combustion chamber. The supply device 1 comprises a tube 2 providing an outer lateral wall 3 of the supply device. The tube 2 is preferably in the form of a straight lance, typically rotationally symmetric about a central longitudinal axis of the tube, except for the nozzle arrangements 4 arranged through the lateral wall 3. A plurality of nozzle arrangements 4, e.g. two, three, four or five nozzle arrangements 4, are arranged through the outer wall 3 of the tube 2, for allowing gases to flow into the combustion chamber via the nozzle arrangement from piping enclosed within the tube 2. Said piping, herein called inner and outer piping, typically enters the tube 2 at an (outer) one of the two ends of the tube. Additionally, the tubular supply device is typically provided with a cooling duct (not shown) within the tube 2, for circulating cooling fluid in the supply device 1, keeping the temperature within the supply device within a suitable range when exposed to heat from the combustion of fuel in the combustion chamber. Typically, the cooling duct is arranged such that the cooling fluid enters and exits the tube 2 at the same (outer) end of the tube.

Each nozzle arrangement 4 comprises an inner nozzle 5 concentrically arranged within an outer nozzle 6. The inner nozzle 5 is connected to, e.g. substantially part of, inner piping 7 of the supply device, within the tube 2 and arranged to provide a fluid connection with an oxygen source, for allowing gaseous oxygen (O₂) to flow from the oxygen source via the inner piping 7 to exit the supply device from the inner nozzle 5. The oxygen source may preferably provide substantially pure oxygen, e.g. containing at least 99% oxygen and less than 1% impurities. Similarly, the outer nozzle 6 is connected to, e.g. substantially part of, outer piping 8 of the supply device, within the tube 2 and arranged to provide a fluid connection with a carbon dioxide source, for allowing gaseous carbon dioxide (CO₂) to flow from the carbon dioxide source via the outer piping 8 to exit the supply device from the outer nozzle 6. Since the outer nozzle 6 concentrically surrounds the inner nozzle 5, the outer piping 8, at least by/at the nozzle arrangement, will enclose the inner piping 7, e.g. the inner piping 7 running inside and in parallel with the outer piping 8, as part of the supply device 1 within the tube 2, why the respective piping is herein called “inner” and “outer”. Of course, at some point, the inner piping 7 will pass through a lateral wall of the outer piping 8 to instead connect to the oxygen source outside of the outer piping.

According to the present invention, the outer piping 8 is part of a recirculation loop for flue gas formed by the combustion in the combustion chamber. The carbon dioxide source can thus be said combustion chamber. However, e.g. during start-up of the plant, there may not be enough carbon dioxide in the recirculation loop, why carbon dioxide may additionally or alternatively be supplied to the outer piping 8 from a carbon dioxide storage storing substantially pure carbon dioxide, e.g. containing at least 99% carbon dioxide and less than 1% impurities.

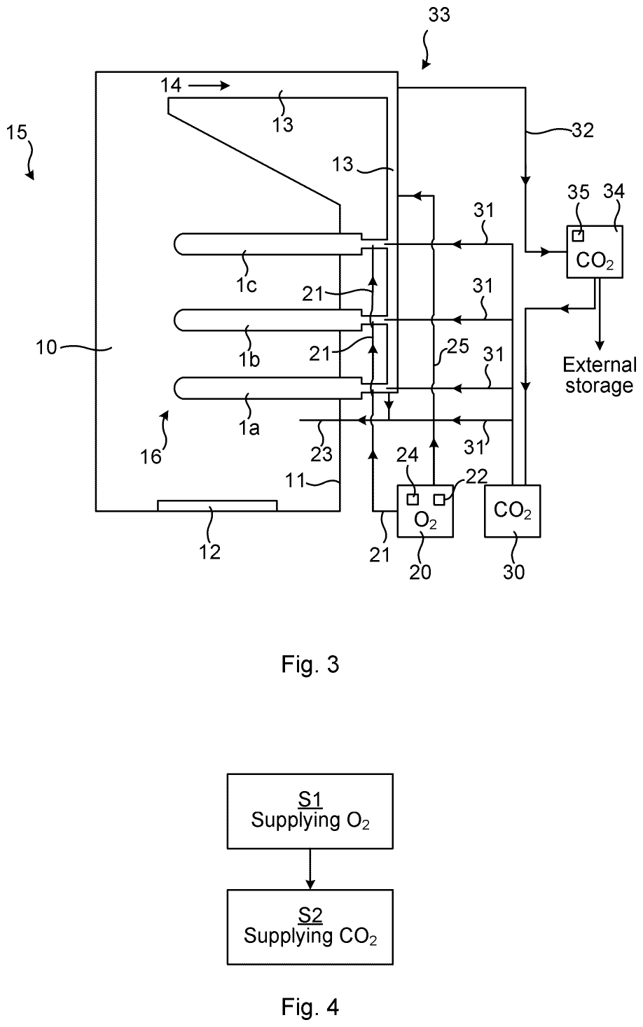

FIG. 3 illustrates a heat-generating plant 15 comprising a combustion chamber 10 in which fuel is combusted in the presence of oxygen, e.g. at a hearth 12, to produce carbon dioxide in flue gas 14.

The plant 15 also comprises a supply system 16 comprising a plurality of the tubular supply devices 1 discussed herein. In the figure, three supply devices 1a, 1b and ic are shown as part of the system 16. Each of the tubular supply devices 1 may extend horizontally through a side wall 11 of the combustion chamber 10, and into said combustion chamber. Each of the tubular supply devices may be arranged to be retractable through the side wall 11, e.g. for service, cleaning or the like. Preferably, for each of the supply devices 1, its tube 2 extends into the combustion chamber 10 from, typically through, a side wall 11. As mentioned above, the tube 2 is typically a straight lance having a central longitudinal axis, whereby one (outer) of the two ends of the tube 2 is arranged in or at the wall 11 while the other (inner) of the two ends of the tube 2 is inside the combustion chamber 10, facing an opposite side wall. An advantage of the straight lance form of the tube 2 is that the tube 2, and thus the supply device 1, can be arranged axially movable through a hole in the side wall 11. Thus, the supply device 1 can be inserted and/or retracted axially through a hole in the side wall 11. This allows e.g. a new supply device 1 to be inserted into the combustion chamber, a supply device 1 to be retracted and cleaned or serviced outside of the combustion chamber, and/or to vary the distance the supply device 1 extends into the combustion chamber and/or to rotate the supply device 1 e.g. to optimize the oxygen supply and thus the combustion in the combustion chamber. Typically, each tube 2 (and thus supply device 1) extends into the combustion chamber 10 in a direction which is perpendicular to the side wall 11, and/or in a horizontal direction.

Typically, for each supply device 1, each of the nozzle arrangements 4 is arranged for expelling the gas in a direction which is perpendicular to the outer lateral wall 3, typically towards the hearth 12, e.g. vertically downward in the combustion chamber 10, depending on the design of the combustion chamber. In some embodiments, the gas may be expelled, and some or all of the nozzle arrangements 4 are arranged to expel the gas, in a direction towards the hearth at an angle within the range of 30-90° to the (plane of the) hearth. However, in some embodiments, it may be preferred to expel the gas in a direction which is towards the hearth 12 but not directly towards said hearth, e.g. not in a direction perpendicular to (a plane of) the hearth, but rather in a direction slanting towards the hearth, e.g. in a direction inclined in relation to (a plane of) the hearth. In some embodiments, the gas may be expelled, and some or all of the nozzle arrangements 4 are arranged to expel the gas, in a direction towards the hearth but forming an angle within the range of 30-60° to the (plane of the) hearth, e.g. 45°, in contrast to a perpendicular direction of 90°. For example, if the hearth 12 is arranged at the bottom of the combustion chamber 10, and the plane of the hearth is horizontal, which is usually the case, the gas may be expelled, and some or all of the nozzle arrangements 4 are arranged to expel the gas, in a direction forming an angle within the range of 30-60° to the horizontal plane of the hearth, e.g. 45°. Alternatively, in other embodiments, the gas may be expelled, and some or all of the nozzle arrangements 4 are arranged to expel the gas, in a direction forming an angle of 90° to the horizontal plane of the hearth, i.e. vertically downward in the combustion chamber.

The supply devices may advantageously be arranged at different distances downstream of the hearth 12 (“downstream” referring to the direction of travel of combustion/flue gases in the combustion chamber during operation), allowing different mixtures of the oxygen and carbon dioxide to be expelled into different combustion zones within the combustion chamber 10. It may e.g. be convenient to expel a gas mixture having a higher oxygen content closer to the hearth 12 in the combustion chamber and a gas mixture having a lower oxygen content further from the hearth 12 in the combustion chamber, to allow as much as possible of the oxygen to be consumed to form carbon dioxide, i.e. to reduce the amount of oxygen in the flue gas 14 exiting the combustion chamber, e.g. to below 1% of the flue gas 14 when disregarding any water vapour in the flue gas. Thus, in some embodiments, for each of the tubular supply devices 1, an oxygen content in the gases (i.e. gas mixture of oxygen and carbon dioxide/flue gas) expelled into the combustion chamber 10 via the nozzle arrangements 4 is different from the other of the tubular supply devices. In some embodiments, the oxygen content expelled from the tubular supply device 1a closest to the hearth 12 is higher than the oxygen content expelled from the tubular supply device 1c furthest from the hearth, e.g. wherein the oxygen content is within the range of 25-40% for the closest one 1a and/or the oxygen content is within the range of 5-15% for the furthest one 1c. In some other embodiments, such as for NOx reduction, it may instead be desirable to expel a gas mixture having a lower oxygen content closer to the hearth 12 in the combustion chamber and a gas mixture having a higher oxygen content further from the hearth 12 in the combustion chamber 10. Thus, in some embodiments, the oxygen content expelled from the tubular supply device 1a closest to the hearth 12 is lower than the oxygen content expelled from the tubular supply device 1c furthest from the hearth, e.g. wherein the oxygen content is within the range of 5-15% for the closest one 1a and/or the oxygen content is within the range of 25-40% for the furthest one 1c. For a vertical combustion chamber, as shown in the figure, where the combustion gases travel upward passed the supply devices 1, the supply devices 1 may preferably be arranged at different heights in the combustion chamber.

The flue gas recirculation loop 13 directs flue gas from the top of the combustion chamber 10 into the outer piping 8 in each of the supply devises 1, from which the recirculated flue gas is expelled back into the combustion chamber 10 from the outer nozzles 6. Flue gas piping 33 may be arranged to divide some or all the flue gas from the combustion chamber 10 between the flue gas recirculation loop 13 and the carbon dioxide storage arrangement 34 via CCS piping 32 connecting the carbon dioxide storage arrangement 34 with the flue gas recirculation loop 13 and allowing some of the flue gas 14 of the recirculation loop 13 to flow to the carbon dioxide storage arrangement 34 via the CCS piping 32. If all the flue gas 14 from the combustion chamber 10 is divided between the flue gas recirculation loop 13 and the carbon dioxide storage arrangement 34, no flue gas is released into the environment and a chimney may no longer be needed. The recirculation loop 13 may comprise a condenser (not shown) for removing water from the flue gas 14, providing substantially dry flue gas, e.g. with less than 1% gaseous water, in the flue gas entering the supply devices 1 and the CCS piping 32. The need for removing gaseous water from the flue gas typically depends on the water content of the fuel combusted in the combustion chamber. Any conventional fuel may be used. The carbon dioxide storage arrangement 34 may optionally comprise a purification system 35 for removing impurities from the flue gas, to produce substantially pure carbon dioxide, e.g. of at least 99% carbon dioxide and less than 1% impurities, which may then be transported to an external (e.g. final) storage and/or to the carbon dioxide storage 30 for later supply to the supply devices 1.

The carbon dioxide storage 30 may contain substantially pure carbon dioxide, e.g. of at least 99% carbon dioxide and less than 1% impurities, and may be used for supplying gaseous carbon dioxide via carbon dioxide piping 31 to each of the supply devices 1, specifically to the outer piping 8 therein, when needed, e.g. during a start-up phase of the plant 15 before the flue gas recirculation has reached steady-state.

The oxygen source 20 may provide the gaseous oxygen to the inner piping in each of the supply devices 1 via oxygen piping 21. The oxygen source 20 typically comprises an oxygen storage container holding substantially pure oxygen containing at least 99 vol % oxygen (at most 1% impurities). The oxygen source may comprise an electrolyser 22 for decomposing water into hydrogen and the pure oxygen supplied to the supply devices 1 via the oxygen piping 21. The hydrogen may be stored and used for other applications or sold. The pure oxygen produced by the electrolyser 22 may typically have an overpressure within the range of 0.2-1 bar or 0.5-1 bar, but this may not be enough to expel the desired amount of oxygen from the inner nozzles 5 via the relatively narrow inner piping 7. Thus, the oxygen source 20 may comprise a compressor 24 for providing the oxygen to the oxygen piping at an increased over pressure, typically within the range of 5-8 bar. The oxygen piping 21 may then be regarded as high-pressure (HP) oxygen piping 21.

The oxygen expelled into the combustion chamber 10 from the inner nozzles 5 may not be enough for the fuel combustion in the combustion chamber. Thus, further oxygen from the oxygen source 20 may be added to the flue gas recirculation loop 13, downstream of any flue gas piping 33 diverting some of the flue gas to the carbon dioxide storage arrangement 34. For this, wider oxygen piping 25 may be used why oxygen at a lower pressure may be used, e.g. at an overpressure within the range of 0.2-1 bar or 0.5-1 bar obtained directly from the electrolyser 22 without the need for a compressor 24. The oxygen piping 25 may then be called low-pressure (LP) oxygen piping 25.

Optionally, the supply system 16 may comprise at least one auxiliary supply arrangement 23 for supplying oxygen, e.g. mixed with flue gas 14 from the recirculation loop 13 and/or carbon dioxide from the carbon dioxide storage 30, into the combustion chamber in addition to the supply devices 1, preferably closer to the hearth 12 than the closest, e.g. lowest, supply device 1a, for providing enough oxygen for improved combustion within the combustion chamber 10. In some embodiments, a majority of the oxygen supplied to the combustion chamber 10 may be by the auxiliary supply arrangement(s) 23, a minority being supplied by the tubular supply device(s) 1. For instance, at least 80%, e.g. at least 90%, of the oxygen supplied to the combustion chamber 10 may be by the auxiliary supply arrangement(s) 23. The tubular supply devices 1 may be used to fine tune the oxygen supply to the combustion chamber to minimize the amount of oxygen in the flue gas 14.

As illustrated in FIG. 3, and in some embodiments of the present invention, oxygen from the oxygen supply 20, providing pure oxygen, may be provided into the combustion chamber 1 via three different paths: via the HP oxygen piping 21, the inner piping 7 and expelled from the inner nozzles 5; via the LP oxygen piping 25, the outer piping 8 and expelled from the outer nozzles 6; and via the LP oxygen piping 25 and auxiliary supply arrangement(s) 23. These different paths will now be discussed in more detail.

The oxygen expelled into the combustion chamber from the inner nozzles 5 is pure oxygen. However, the flow of the pure oxygen in the inner piping 7 in each respective supply device 1 can be regulated, and even turned off completely, to adjust or fine tune the amount of oxygen supplied by the supply device 1. This allows for supplying different amounts or concentrations of oxygen in different zones in the combustion chamber. A minor part of the total amount of oxygen provided into the combustion chamber from the oxygen supply 20 may be by this path, i.e. expelled from the inner nozzles 5, e.g. at most 20% or at most 10%, or within the range of 5-15% of the total amount. As mentioned above, the oxygen supplied to the HP oxygen piping 21 from the oxygen source 20 may conveniently be at a relatively high pressure, e.g. provided by a compressor 24, for instance an overpressure within the range of 5-10, preferably 7-8 bar.

The oxygen which is optionally expelled into the combustion chamber from the outer nozzles 6 is mixed with flue gas 14 in the flue gas recirculation loop 13, e.g. to an oxygen concentration within the range of 0-30%. The oxygen added to the recirculation loop 13 may be from the LP oxygen piping 25. As mentioned above, the oxygen supplied to the LP oxygen piping 25 from the oxygen source 20 may be at a relatively low pressure, e.g. at an overpressure within the range of 0.2-1 bar or 0.5-1 bar.

The oxygen which is optionally expelled into the combustion chamber 10 from the one or more auxiliary supply arrangements 23 may be pure oxygen or, preferably, mixed with flue gas from the recirculation loop 13 or with pure carbon dioxide from the carbon dioxide storage 30 via the carbon dioxide piping 31. If the oxygen is mixed with flue gas from the flue gas recirculation loop 13, this flue gas may in some embodiments be pure flue gas, taken upstream of any oxygen addition via the LP oxygen piping 25, or it may already have been mixed with oxygen from the LP oxygen piping 25. Regardless of how the oxygen in the auxiliary supply arrangements 23 is mixed, in embodiments where it is mixed and not pure oxygen, the oxygen concentration in the gas mixture expelled into the combustion chamber from each of the auxiliary supply arrangements 23 may preferably be within the range of 15-25%. The oxygen added to the auxiliary supply arrangements 23 may be from the LP oxygen piping 25. As mentioned above, the oxygen supplied to the LP oxygen piping 25 from the oxygen source 20 may be at a relatively low pressure, e.g. at an overpressure within the range of 0.2-1 bar or 0.5-1 bar.

FIG. 4 illustrates some embodiments of the method of the present invention. The method is for supplying gases to the combustion chamber 10 in a heat-generating plant 15, wherein the plant 15 comprises at least one tubular supply device 1 of the present disclosure. The method comprises, from the oxygen source 20, supplying S1 gaseous pure oxygen into the combustion chamber 10 via the inner nozzle 5, and thus typically via the inner piping 7, of each of the nozzle arrangements 4. The method also comprises supplying S2 gaseous carbon dioxide, e.g. from the flue gas recirculation loop 13 and/or from the carbon dioxide storage 30, into the combustion chamber 10 via the outer nozzle 6, and thus typically via the outer piping 8, of each of the nozzle arrangements 4.

Generally, some embodiments of the present invention provide embodiments of the tubular supply device 1 discussed herein, for supplying gases to a combustion chamber 10 in a heat-generating plant 15. The supply device 1 comprises a tube 2 having an outer lateral wall 3, the tubular supply device 1 extending into the combustion chamber 10 from a side wall 11 of said combustion chamber. The supply device 1 comprises a plurality of nozzle arrangements 4 for expelling the gases into the combustion chamber 10. Each nozzle arrangement 4 comprises an inner nozzle 5 connected to an oxygen source 20. The inner nozzle 5 is arranged for supplying pure oxygen from said oxygen source 20 into the combustion chamber 10. Each nozzle arrangement 4 also comprises an outer nozzle 6 connected in a flue gas recirculation loop 13 of the plant 15. The outer nozzle 6 is arranged for supplying flue gas 14 flowing in said flue gas recirculation loop 13 into the combustion chamber 10.

The present disclosure has mainly been described above with reference to a few embodiments. However, as is readily appreciated by a person skilled in the art, other embodiments than the ones disclosed above are equally possible within the scope of the present disclosure, as defined by the appended claims.

1-18. (canceled)

19. A heat-generating plant comprising:
a combustion chamber;
an oxygen source;
a flue gas recirculation loop; and
at least one tubular supply device extending into the combustion chamber from a side wall of said combustion chamber, for supplying gases to the combustion chamber;
wherein each at least one tubular supply device comprises:
a tube in a form of a straight lance and having an outer lateral wall; and
a plurality of nozzle arrangements arranged through the outer lateral wall for expelling the gases into the combustion chamber from within the tube in a direction which is perpendicular to the outer lateral wall, each of the plurality of nozzle arrangements comprising:
an inner nozzle connected to the oxygen source via inner piping in the tubular supply device and arranged for supplying pure oxygen from said oxygen source into the combustion chamber via said inner piping and the inner nozzle; and
an outer nozzle, surrounding the inner nozzle, connected in the flue gas recirculation loop via outer piping in the tubular supply device and arranged for supplying flue gas flowing in said flue gas recirculation loop into the combustion chamber via said outer piping and the outer nozzle, the outer piping enclosing the inner piping at the respective nozzle arrangement within the tube.

20. The heat-generating plant of claim 19, wherein the outer nozzle is further connected to a carbon dioxide storage via the outer piping and arranged for supplying pure carbon dioxide from said carbon dioxide storage into the combustion chamber via said outer piping and the outer nozzle.

21. The heat-generating plant of claim 19, wherein each of the plurality of nozzle arrangements is arranged for expelling respective gases in a direction vertically downwards towards hearth in the combustion chamber.

22. The heat-generating plant of claim 19, wherein each of the plurality of nozzle arrangements is arranged for expelling respective gases in a direction at an angle within a range of 30-60° to a hearth located in the combustion chamber.

23. The heat-generating plant of claim 19, wherein the oxygen source contains substantially pure oxygen containing at least 99% oxygen.

24. The heat-generating plant of claim 19, wherein the oxygen source comprises an electrolyser for decomposing water into hydrogen and the pure oxygen.

25. The heat-generating plant of claim 19, wherein the at least one tubular supply device comprises a plurality of tubular supply devices arranged at respective different distances downstream of a hearth within the combustion chamber.

26. The heat-generating plant of claim 19, further comprising an auxiliary supply arrangement, separate from the at least one tubular supply device, for supplying gaseous oxygen from the oxygen source into the combustion chamber.

27. The heat-generating plant of claim 19, further comprising:
a carbon dioxide storage arrangement; and
flue gas piping (33) arranged to divide all the flue gas from the combustion chamber between the flue gas recirculation loop and the carbon dioxide storage arrangement.

28. A method for supplying gases to a combustion chamber in a heat-generating plant comprising:
the combustion chamber;
an oxygen source;
a flue gas recirculation loop; and
at least one tubular supply device extending into the combustion chamber from a side wall of said combustion chamber, for supplying gases to the combustion chamber;
wherein each at least one tubular supply device comprises:
a tube in a form of a straight lance and having an outer lateral wall; and
a plurality of nozzle arrangements arranged through the outer lateral wall for expelling the gases into the combustion chamber from within the tube in a direction which is perpendicular to the outer lateral wall, each of the plurality of nozzle arrangements comprising:
an inner nozzle connected to the oxygen source via inner piping in the tubular supply device and arranged for supplying pure oxygen from said oxygen source into the combustion chamber via said inner piping and the inner nozzle; and
an outer nozzle, surrounding the inner nozzle, connected in the flue gas recirculation loop via outer piping in the tubular supply device and arranged for supplying flue gas flowing in said flue gas recirculation loop into the combustion chamber via said outer piping and the outer nozzle, the outer piping enclosing the inner piping at the nozzle arrangement within the tube;
the method comprising:
from the oxygen source, supplying (S1) gaseous pure oxygen into the combustion chamber via the inner piping and the inner nozzle of each of the plurality of nozzle arrangements; and
supplying gaseous carbon dioxide into the combustion chamber via the outer piping and the outer nozzle of each of the plurality nozzle arrangements.

29. The method of claim 28, wherein at least a part of the supplied gaseous carbon dioxide is comprised in recirculated flue gas flowing in the flue gas recirculation loop.

30. The method of claim 29, wherein the recirculated flue gas is dry.

31. The method of claim 28, wherein the outer nozzle is connected to a carbon dioxide storage and the supplied gaseous carbon dioxide is pure carbon dioxide from the carbon dioxide storage.

32. The method of claim 28, wherein the at least one tubular supply device comprises a plurality of tubular supply devices, each arranged at a different distance from a hearth within the combustion chamber.

33. The method of claim 32, wherein, a respective oxygen content in respective gases expelled into the combustion chamber by each of the tubular supply devices, is different from a respective oxygen content in respective gases expelled into the combustion chamber by each other tubular supply device.

34. The method of claim 33, wherein:
the plurality of tubular supply devices comprises one or more first tubular supply devices located a first distance from the hearth, and one or more second tubular supply devices located a second distance from the hearth, wherein the second distance is greater than the first distance; and
a respective oxygen content in first gases expelled into the combustion chamber from the one or more first tubular supply devices is higher than a respective oxygen content in second gases expelled into the combustion chamber from the one or more second tubular supply devices.

35. The method of claim 34, wherein the respective oxygen content in the first gases is within a range of 25-40%, and the respective oxygen content in the second gases is within a range of 5-15%,

36. The method of claim 33, wherein:
the plurality of tubular supply devices comprises one or more first tubular supply devices located a first distance from the hearth, and one or more second tubular supply devices located a second distance from the hearth, wherein the second distance is greater than the first distance; and
a respective oxygen content in first gases expelled into the combustion chamber from the one or more first tubular supply devices is lower than a respective oxygen content in second gases expelled into the combustion chamber from the one or more second tubular supply devices.

37. The method of claim 36, wherein the respective oxygen content in the first gases is within a range of 5-15%, and the respective oxygen content in the second gases is within a range of 25-40%.

38. The method of claim 28, wherein the gaseous carbon dioxide supplied via the outer nozzle is mixed with oxygen to an oxygen concentration within a range of 1-30%, in the flue gas recirculation loop.
